(19) United States
(12) Patent Application Publication
(10) Pub. No.: US 2009/0263565 A1
(43) Pub. Date: Oct. 22, 2009

(54) PROTEINACEOUS FOODSTUFF

(75) Inventors: Lyndon Francis Ryder, Victoria (AU); Melissa Toh, Sydney (AU); Douglas Ian Cole, Victoria (AU)

Correspondence Address: K&L Gates LLP, P.O. Box 1135, CHICAGO, IL, 60690, US

(73) Assignee: NESTEC S.A., Vevey (CH)

(21) Appl. No.: 12/375,813

(22) PCT Filed: Aug. 6, 2007
(86) PCT No.: PCT/AU2007/001104

§ 371 Date: Apr. 14, 2009

(30) Foreign Application Priority Data
Aug. 14, 2006 (AU) 2006203507

(51) Int. Cl. A23J 1/00

(52) U.S. Cl. 426/656; 426/520

(57) ABSTRACT

An extruded foodstuff having a protein content in the range of 45% to 80% protein by mass and specific density of 0.10-0.40 g/cm³, including: a vegetable protein isolate which has been at least partly hydrolysed by enzymic hydrolysis, which provides the majority of the protein content and which has a relatively low level of low molecular weight peptides and which has a relatively low water imbibing capacity; up to 30% by mass of wheat gluten; up to 5% by mass of the foodstuff is sodium bicarbonate.

### FIELD OF THE INVENTION

The invention relates to the field of commercial extruded food production. In particular, the invention relates to a formulation for a relatively high-protein extruded foodstuff of improved organoleptic properties.

### BACKGROUND OF THE INVENTION

Extruded, low-moisture (usually shelf-stable) foodstuffs are a staple component of many commercial food products, ranging from pet foods to breakfast cereals and savoury snacks. Typically, these foodstuffs are composed primarily of starchy and/or fibrous materials.

These starch based materials have proved to be excellent materials for producing extruded foods of desirable organoleptic properties, including flavour, crispness and ability to display an expanded, ‘light’ texture even when immersed in fluid such as milk. These properties tend to be associated with a specific density in the range 0.10-0.40 g/cm³.

However, nutritional requirements identified in recent times have emphasised the desirability of relatively high protein levels in human foods, in preference to carbohydrates, such as starch. This has led food manufacturers to investigate the manufacture of relatively high protein extruded foodstuffs, i.e. protein levels above about 20% by mass, as alternatives to the more traditional formulations.

However, some of the disadvantages which, unfortunately, have tended to be associated with high-protein formulations for extruded foodstuffs include:
high raw material cost, especially for highly functional food protein sources such as egg protein or blood plasma;
bitter flavour notes;
dense, hard structure;
unacceptable ‘pasty’ or ‘gritty’ mouthfeel for more extensively degraded protein chains; and
unacceptable ‘chewy’ or ‘rubbery’ mouthfeel.

One attempt to address some of these issues is disclosed in WIPO Patent Document No. WO 2005/096834, by Solae LLC. In this document, the use of partially hydrolysed soy protein in the formulation is described to contribute to an ability produce a relatively high-protein extruded foodstuff having a density similar to high-starch counterparts. However, the products disclosed in this document are likely to still have appreciable disadvantages in flavour profile and mouthfeel/texture compared with starch-based counterparts, due to typical organoleptic problems associated with soy extrusion, as discussed above.

Another such product is that disclosed in US Patent Document No. 6,242,033 by Sander. This document describes the manufacture of an extruded breakfast cereal product which has a protein content of 60% by mass or higher with the reportedly advantageous inclusion of a starch derived from a tuber.

Accordingly, it is an object of the invention to provide an extruded foodstuff having a protein level in the range of 45% to 80% by mass, which overcomes at least some of the disadvantages of the prior art by more closely approximating the flavour and texture of a starch-based extruded foodstuff, whilst utilising an economically feasible formulation.

### SUMMARY OF THE INVENTION

An extruded foodstuff, having a protein content in the range of 45% to 80% protein by mass and specific density of 0.10-0.40 g/cm³, including:

a vegetable protein isolate which has been at least partly hydrolysed by enzymic hydrolysis, which provides the majority of the protein content and which has a relatively low level of low molecular weight peptides and which has a relatively low water imbibing capacity;

up to 30% by mass of wheat gluten;

up to 5% by mass of the foodstuff is sodium bicarbonate.

The use of a vegetable protein isolate as defined above, which has been at least partly hydrolysed via enzyme hydrolysis, providing the bulk of the protein in the final product, greatly assists in producing an acceptable flavour profile with a satisfactory extrusion performance during manufacture. This formulation also allows the product to exhibit a significantly enhanced texture, particularly in a relatively high moisture environment (such as where the extruded product is included in a breakfast cereal which is to be immersed in milk). In such an environment, the foodstuff displays markedly lower ‘pastiness’ or ‘rubberiness’ than the foodstuffs according to the prior art.

Vegetable protein isolates as used in traditional applications in the meat analogue and beverage industries tend to either be of a high molecular weight (i.e. un-hydrolysed) or a low molecular weight (i.e. hydrolysed for solubility) in these respective applications. Application of such isolates in the cereal and snack food industries is relatively less common. The inventors have found that extrusion with those kind of isolates produced defects, such as poor extrusion properties, unacceptable “beany” flavours, unsuitable viscosity profiles and low solubility amongst others.

In the evaluation of suitable protein isolates for extrusion of a foodstuff applicable to the breakfast and snack food industries, it was found that extrusion of a high molecular weight (un-hydrolysed) vegetable, particularly soy, protein isolate had fewer flavour defects and were more bland (as compared to most hydrolysed isolates) but yielded textures that were less optimal, particularly when the extrudate was exposed to a liquid such as milk. It was observed that a seemingly crisp extrudate (when dry), developed a chewy, rubbery texture when immersed in liquid. This may be due to the high water imbibing capacity (WIC) of high molecular weight proteins.

Vegetable protein isolates of high solubility, which are enzyme-modified to varying degrees of hydrolysis, as commonly used in the prior art to overcome some of the undesirable properties of high molecular weight, or un-hydrolysed, soy protein isolates, were evaluated by the inventors. However, a common unfortunate side effect of hydrolysis was found to be the generation of short amino acid fragments resulting in unpleasant bitter flavours in the isolate that were found to persist through to the final product. No satisfactory method entirely removing or masking these bitter compounds was found, necessitating the use of the vegetable protein isolates as defined above.

The vegetable protein isolates as defined above were found to exhibit desirable organoleptic effects both in a low moisture, and high moisture environment.

The wheat gluten mitigates some of the typical disadvantages associated with the extrusion of soy protein. In particular, vital wheat gluten provides a bland to slightly cereal flavour to the product, reducing the bitterness which can be associated with soy-based extrusions. Gluten inclusion also tends to improve the crispness of the extrudate, which is vital where they are to be included in breakfast cereal products and where extended bowl-life (ability to maintain crispness in milk) is required. Use of gluten tends to provide a superior organoleptic performance as compared with the prior art soy-based foodstuffs, while having the added advantage of being a relatively low-cost protein source.

Preferably, said vegetable protein isolate is soy protein isolate and said wheat gluten is vital wheat gluten.

The presence of sodium bicarbonate greatly assists in eliminating ‘grifty’ mouthfeel from the final product. This effect is thought to be due to sodium bicarbonate reducing the amount of protein aggregation occurring as the melt cools below the glass transition temperature either as a result of modifying the pH of the extrudate or other interaction with the protein.

Preferably, said foodstuff further includes up to 25% by mass of a vegetable or grain starch. The presence of the starch assists in improving the texture of the foodstuff, mitigating the tendency of cooked protein to form hard or rubbery products. Preferably, said vegetable or grain starch is a high amylopectin starch, such as tapioca starch. Such starches tend to have desirable synergistic effects with proteins in extrusion conditions. Starches derived from tubers are thought to support expansion of the cereal product exiting the die such that the extruded expanded product resembles a typical expanded cereal product.

Advantageously, said foodstuff further contains up to 5% by mass of a sugar. This is likely to provide enough reducing sugars, after extrusion processing, to produce significant Maillard reaction products to improve both the product flavour and colour. Preferably, said sugar is sucrose.

More advantageously, said foodstuff further contains up to 10% by mass of a dairy protein. This addition provides pleasant creamy, dairy flavour notes in the foodstuff, together with development of appealing golden colours in the foodstuff. It is likely that the rapid development of these colour and flavouring compounds results from Maillard reactions between the proteins and reducing sugar (lactose) found in the dairy protein.

In addition, extruder running conditions when dairy protein was included in the formulation these levels indicate that dairy protein is associated with higher extruder torque, higher specific mechanical energy (SME) and higher die pressure, resulting in extrudates having higher density compared to similar products without dairy protein. These higher energy inputs are usually also associated with stable extrusion conditions.

According to another aspect of the invention, there is provided a process for producing a foodstuff according to that described above, including a post-extrusion processing step which facilitates Millard browning reactions in said foodstuff. Preferably, said processing step includes toasting.

According to another aspect of the invention, there is provided a food product incorporating an extruded foodstuff according to that described above.

According to another aspect of the invention, there is provided the use of sodium bicarbonate to improve the mouthfeel of an extruded, toasted foodstuff having protein content in the range of 45% to 80% protein by mass.

According to another aspect of the invention, there is provided the use of vital wheat gluten to improve the flavour and/or mouthfeel of an extruded, toasted foodstuff having protein content in the range of 45% to 80% protein by mass.

According to another aspect of the invention, there is provided the use of a milk protein concentrate to improve the flavour and colour of an extruded, toasted foodstuff having protein content in the range of 45% to 80% protein by mass.

According to another aspect of the invention, there is provided the use of tapioca starch to modify the texture of an extruded, toasted foodstuff having protein content in the range of 45% to 80% protein by mass.

Now will be described, by way of specific, non-limiting examples, preferred embodiments of the invention.

### DETAILED DESCRIPTION OF A PREFERRED EMBODIMENT

The work of the inventors forms part of a study to determine the potential role of various broad ingredient types, and specific examples of those ingredients, in improving the organoleptic properties of extruded, toasted foodstuffs having a protein content in the range of 45% to 80% protein by mass specific density of 0.10-0.40 g/cm³. Broadly, the inventor's conclusions are now discussed.

The choice of soy isolate as the main protein source for the high protein foodstuff was the result of a compromise between extrusion performance, taste, and cost. When compared to other protein sources such as gluten, soy protein extruded fairly well at high concentrations. However, when benchmarked against a traditional starch matrix, textural hurdles still needed to be overcome, with the protein-based extrudate displaying undesirable textural properties such as ‘pastiness’, which can be defined as a weak structural characteristic of the extrudate that collapsed in the mouth and gave a thick, ‘slimy’ mouthfeel; and ‘rubberiness’, which can be defined as a tough, leathery and chewy texture in the mouth, particularly when the extrudate came into contact with a liquid such as milk.

There were also flavour issues with soy, predominantly bitter notes which were noticeable when some types of extensively hydrolysed soy proteins were used as part of the formulation mix. Overcoming the technical challenges described above were the focus of the study, and combinations of soy protein isolate with a wide range of other ingredients (e.g. starch, fibre, other proteins, lipids, additives) were investigated to determine ingredient interaction effects and which of these ingredients particular have a positive effect on the palatability of the predominantly protein-based extruded product.

Process variables, including temperature, shear, moisture and pressure, and die designs were also investigated to understand if the desired outcome could be produced by manipulation of the textural characteristics of protein via the process.

Combinations of proteins were tested and extruded in their pure form in the absence of any other food ingredients or additives. This approach was used in an attempt to understand any inherent differences between the various types of proteins and how various processing parameters might be used to manipulate the organoleptic quality of the protein through denaturation effects: re-alignment of protein strands etc. Studies on how other ingredients (starch, lipids, fibre, additives, other proteins) interacted with the protein were carried also out with process manipulations investigated concurrently. The resulting extrudates representative of these ingredient interaction effects and process manipulations were evaluated from a sensory and textural quality perspective (both dry, and hydrated in milk).

The soy proteins tested were all soy protein isolates (SPI) purified from defatted soy grits to contain 90% protein within the isolate as the final concentration. Some isolates requiring high solubility are subsequently enzyme modified to varying degrees of hydrolysis. This enzymic treatment is necessary to transform some of the undesirable properties of ‘native’ or un-hydrolysed, soy protein isolates. These defects include poor extrusion properties, unacceptable “beany” flavours, unsuitable viscosity profiles and poor low solubility amongst others.

On the other hand, when using most hydrolysed soy proteins, a common unfortunate side effect of hydrolysis was found to be the generation of short amino acid fragments resulting in unpleasant bitter flavours in the isolate that were found to persist through to the final product. No satisfactory method entirely removing or masking these bitter compounds was found.

Generally, isolates that were extensively hydrolysed had lower viscosity (suggesting short protein chain lengths (<30 KDa), which was confirmed by SDS-PAGE gel electrophoresis), bitter flavour and produced extrudates with an unpleasant “pasty” mouthfeel.

Wheat gluten has many characteristics that make it a desirable protein source. Gluten provides a bland to slightly ‘cereal’ flavour to the product and at low levels can improve the crispness of extrudates. It possesses none of the flavour or textural defects of the soy isolates tested and has the added advantage of being the lowest cost protein source. This is, however, slightly offset by its lower total protein content (˜75-83%) compared to soy isolates (90%).

The extrusion of cereal blends having more than about 30% gluten have, however, proven to be problematic. At high gluten levels, the extrusion process tends to become unstable with the extrudate exiting the die in violent bursts rather than as well formed shapes. These extrudates also tend to be hard, dense, and unpalatable in that respect. The conclusion was that vital wheat gluten cannot be used as a main protein source in a high (>45%) protein extrudate, but rather, to complement the preferred SPI and to enhance textural qualities and reduce formulation cost. It was noted that as the amount of gluten increased, so did the ‘crunchiness’ of the extrudate. However, it is recommended that a level of no more than 30% vital gluten be used, and more preferably at 20%, as at higher levels, the undesirable qualities of gluten (poor extrusion performance; tough, uneven extrudates) tend to appear.

Dairy protein groups were also tested, including whole milk protein concentrate (WMPC), wherein all of the milk proteins are present in the ratios naturally occurring in bovine milk.

From a nutritional standpoint (PDCAAS score of 1), flavour and functional characteristics, milk proteins do present comparable advantages over most plant proteins (with the exception of soy, which also has a PDCAAS score of 1).

However, the cost of animal protein is generally substantially higher than plant protein, limiting the opportunity for commercialisation of products containing high amounts of this protein type.

WMPC as the sole protein source was trialled to test its extrusion characteristics and suitability. While the material was found to extrude very well and produce stable extrusion conditions, the extrudate formed an unsatisfactory hard, glassy bubble. This may indicate, however, that the material has good film-forming properties and that low level additions might be useful in promoting crispness.

Very pleasant creamy, dairy flavour notes present in the samples together with the easy development of appealing golden colours in the extrudate suggests that WMPC might be useful as both a flavour and colouring agent. It is likely that the rapid development of these colour and flavouring compounds results from Maillard reactions between the abundant protein and reducing sugar (lactose) found in WMPC.

Analysis of the extruder running conditions when MPC was included in the soy isolate-based formulations at significant levels indicates that WMPC is associated with higher extruder torque, higher SME, higher die pressure and usually results in extrudates having higher density compared with similar products without WMPC. These higher energy inputs are usually also associated with stable extrusion conditions.

The conclusion was that WMPC can be used to improve the flavour profile when used as a complementing protein to SPI. Functional characteristics and extrusion performance are quite beneficial, though 5-10% in the overall formulation is recommended to give desired flavour notes while minimising cost.

Native tapioca starch, a high amylopectin starch, was trialled as a texture modifier. Its relatively low cost, bland flavour profile and high viscosity pasting properties makes it an attractive starch source for extruded products. It appears that this starch has a desirable synergistic effect with proteins in extrusion conditions, particularly in the area of enhancing expansion of the extrudate, and reducing the unpalatable nature of proteins.

For the majority of the formulations tested, sucrose was added at around 2% by mass. This level is considerably lower than the addition level normally used but other formulation constraints made higher inclusion levels impractical. For some trials, levels as high as 6% were tested.

At 2%, any masking effect of the unpleasant protein flavours is minimal. Similarly, at 2%, sucrose provides very little sweetness to the final product but it probably does provide improvements to the overall flavour profile as well as improving textural qualities such as adding ‘crunchiness’ to the extrudate.

It is likely that at even at these low levels, the added sucrose can provide enough reducing sugars to produce significant Maillard reaction products, thereby improving both the product flavour and colour.

It was postulated that, in high protein systems, sodium bicarbonate (NaHCO₃) might act to modify the pH of the extrudate melt in the extruder barrel, which, in turn, might affect the protein structure by moving the protein to its isoelectric point, thereby improving solubility.

Under some conditions, sodium bicarbonate is also a gas producer, a property that can be useful in modifying extrudate texture. Sodium bicarbonate does this by acting as a nucleating agent to produce a super-saturated solution of gas in the composition and forming fine bubbles.

The effect and rate of addition of sodium bicarbonate was tested on several occasions and its effect on the texture of the high protein bubble (protein level ˜80%) assessed with the results being inconclusive. Subsequent more detailed testing on lower protein formulations (protein level ˜50%) did, however, demonstrate that sodium bicarbonate is very effective in reducing or eliminating grittiness in the final product. This effect is probably due to sodium bicarbonate reducing the amount of protein aggregation occurring as the melt cools below the glass transition temperature either as a result of modified pH or other interaction with the protein.

The following sections describe example production formulations and processes for extruded, toasted high-protein foodstuffs according to the invention. In particular, the two examples are directed to formulations designed to deliver foodstuffs in two regions of the 45%-80% protein by mass range: one covering 45% to 70% protein by mass covering 70% to 80% protein by mass.

### Example 1

### High Protein Formulation

### Protein ˜70-80%

A typical formulation is given in Table 1.

TABLE 1

| Ingredient | % by mass |
|---|---|
| Soy Protein Isolate (SPI) | 65-75 |
| Vital Wheat Gluten | 10-20 |
| Low Moisture Tapioca Starch | 5-10 |
| Caster Sugar | 1-3 |
| Calcium Carbonate | 1-3 |
| Sodium Chloride | 0.5-2 |
| Sodium Bicarbonate | 0.5-2 |
| Sodium Sulfite | 0-0.5 |

The SPI was Profam 825, a partially enzyme-hydrolysed product supplied by ADM Australia Pty Ltd, of Level 10, 1 Newland Street, Bondi Junction, NSW 2022, Australia.

The above formulation was prepared using a 50 mm twin screw, co-rotating extruder having length/diameter ratio=25:1

The extruder was operated at a feed rate between 20 and 75 kg/hr and fitted with a high shear screw configuration having up to 4 intensive mixing sections.

This configuration was successful and resulted in stable extrusion conditions and the maximum possible barrel fill length. Good product was obtained using this screw profile with bulk density in the range 0.18 to 0.20 gm/cm³ relatively easy to obtain.

The SME using this configuration was generally greater than 0.14 kW.hr/kg and up to 0.2 kW.hr/kg for some trials. Best products were obtained in the range 0.15 to 0.16 kW.hr/kg.

The barrel temperature profile used is given in Table 2.

TABLE 2

| Extruder Barrel | |
|---|---|
| Zone | Temperature (° C.) |
| 2 | 45 |
| 3 | 45 |
| 4 | 45 |
| 5 | 45 |
| 6 | 45 |
| 7 | 60 |
| 8 | 110 |
| 9 | 120 |
| 10 | 140 |

For the majority of the high protein trials, the exact set-points used for the barrel heaters was not considered to have any significant effect on either the process or the product, provided the protein melt temperature was reached close to the die. Accordingly, is strongly recommended the temperature of the melt immediately behind the die is greater than the protein melting temperature. The person skilled in the art would readily be capable of achieving this condition without undue experimentation.

Products produced according to the above formulation were assessed for organoleptic properties, both in dry state and after immersion in milk. The product was judged to have very good flavour and texture, and to have a good bowl life. Overall, the products were judges to be better than those produced by prior art formulations and processes.

### Example 2

### Lower Protein Formulation

### Protein Level ˜45-70%

A typical formulation is given in Table 3.

TABLE 3

| Ingredient | % by mass |
|---|---|
| Soy Protein Isolate (SPI) | 35-50 |
| Low Moisture Tapioca Starch | 15-25 |
| Vital Wheat Gluten | 10-20 |
| Caster Sugar | 5-10 |
| Whole Milk Protein Concentrate | 5-10 |
| (WMPC) | |
| Wheat bran | 5-10 |
| Maltodextrin | 2-5 |
| Calcium Carbonate | 0.5-3 |
| Sodium Chloride | 0.1-1 |
| Sodium Bicarbonate | 0.1-1 |
| Distilled Monoglyceride | 0.1-0.3 |

The SPI was Profam 825, a partially enzyme-hydrolysed product supplied by ADM Australia Pty Ltd, of Level 10, 1 Newland Street, Bondi Junction, NSW 2022, Australia. The WMPC was MPC80, supplied by Murray Goulburn Co-operative Company Ltd, of 140 Dawson St, Brunswick, Victoria 3046, Australia.

The above formulation was prepared using a 50 mm twin screw, co-rotating extruder having length/diameter ratio=25:1. The screw profile was high shear screw configuration having up to four intensive mixing sections. The barrel temperature profile used is given in Table 4.

TABLE 4

| Extruder Barrel | |
|---|---|
| Zone | Temperature (° C.) |
| 2 | 40 |
| 3 | 40 |
| 4 | 40 |
| 5 | 60 |
| 6 | 80 |
| 7 | 100 |
| 8 | 120 |
| 9 | 140 |
| 10 | 150 |

As for example 1, the exact set-points used for the barrel heaters was not considered to have any significant effect on either the process or the product, provided the protein melt temperature was reached close to the die.

The requirement to achieve a fully developed melt behind the die appears to be as important for the mid-protein level process as it is for the high protein level process but, in practice, the lower protein content of the mid protein formulation means this requirement is almost automatically achieved.

The higher starch content used in the mid protein formulation appears to lower the system melt temperature and, at the same time, the lower water requirement of the mid protein formulations means the melt moisture content is significantly less than for the high protein formulation.

Both these effects act to produce a fully developed melt behind the die in almost all processing conditions tested. Die temperatures mostly ranged from 150 to 180° C. with the best results being achieved at around 175° C.

For both ‘sticks’ and ‘small spherical bubbles’ extrusion pieces, best results at low flow rates (around 25 kg/hr dry feed) were obtained using 2 inserts, each 3×1.5 mm diameter circular holes×2 mm land length resulting in die flow rates of 4.2 kg/hr/hole and overall conductivity of 0.373 mm³.

At higher flow rates (100 kg/hr dry feed), the die area was increased to 2 inserts, each 32×1.5 mm diameter circular holes×3.5 mm land length resulting in die flow rates of 1.56 kg/hr/hole and overall die conductivity of 2.272 mm³.

At full factory scale (500 kg/hr dry feed), a single piece die having 138 holes, 1.6 mm diameter×2.5 mm land length was used resulting die flow rates of 3.79 kg/hr/hole and overall die conductivity of 8.879 mm³.

For both of the above examples, it is recommended that the extrusion and colour/flavour development processes are decoupled. This decoupling allows the extrusion rate to be maximised followed by desirable flavour and colour attributes development using air impingement toasting.

During the above trials, a small batch toaster was used to produce colour and toasted flavour notes in the extrudate and to provide final drying. Typical toasting conditions were 180° C. for 5 minutes or 200° C. for 2.5 minutes. None of these conditions were optimised but it appears that a wide range of temperatures and times would produce an acceptable product.

At high throughput rates during full scale testing, under-processed product from the extruder was also successfully toasted inline using a fluid bed toaster. Best results were obtained using an air temperature of 180° C. at a throughput rate of 500 kg/hr. Again, conditions were not optimised but indications are that a wide range of toasting conditions would be suitable. Toaster residence time was estimated to be 60 seconds.

Products produced according to the above formulation were assessed for organoleptic properties, both in dry state and after immersion in milk. The product was judged to have very good flavour and texture, and to have a good bowl life. Overall, the products were judges to be better than those produced by prior art formulations and processes.

It will be recognised by those skilled in the art that the above description merely provides a few exemplary embodiments of the inventive concept. Other embodiments may be conceived which, while differing in inessential details, remain within the spirit and scope of the invention.

1. An extruded foodstuff having a protein content in the range of 45% to 80% protein by mass and a specific density of 0.10 to 0.40 g/cm³ comprising:
a vegetable protein isolate which has been at least partly hydrolysed by enzymic hydrolysis, and which provides a majority of the protein content and having a relatively low level of low molecular weight peptides and a relatively low water imbibing capacity;
up to 30% by mass of the foodstuff is wheat gluten; and
up to 5% by mass of the foodstuff is sodium bicarbonate.

2. The foodstuff of claim 1, wherein the vegetable protein isolate is soy protein isolate.

3. The foodstuff of claim 1, wherein the wheat gluten is vital wheat gluten.

4. The foodstuff of claim 1, comprising up to 25% by mass of an ingredient selected from the group consisting of a vegetable and grain starch.

5. The foodstuff of claim 1, comprising tapioca starch.

6. The foodstuff of claim 1, comprising up to 5% by mass of a sugar.

7. The foodstuff of claim 6, wherein the sugar is sucrose.

8. The foodstuff of claim 1, comprising up to 10% by mass of a dairy protein concentrate.

9. A process for producing a foodstuff comprising using a post-extrusion processing step to facilitate a Maillard browning reaction in a foodstuff comprising a protein content in the range of 45% to 80% protein by mass and a specific density of 0.10-0.40 g/cm³, a vegetable protein isolate which has been at least partly hydrolysed by enzymic hydrolysis, and which provides a majority of the protein content and having a relatively low level of low molecular weight peptides and a relatively low water imbibing capacity, up to 30% by mass of the foodstuff is wheat gluten, and up to 5% by mass of the foodstuff is sodium bicarbonate.

10. The process of claim 9, wherein the processing step includes toasting.

11. An extruded foodstuff produced according to the process of claim 9.

12. A food product incorporating an extruded foodstuff having a protein content in the range of 45% to 80% protein by mass and a specific density of 0.10-0.40 g/cm³, a vegetable protein isolate which has been at least partly hydrolysed by enzymic hydrolysis, and which provides a majority of the protein content and having a relatively low level of low molecular weight peptides and a relatively low water imbibing capacity, up to 30% by mass of the foodstuff is wheat gluten, and up to 5% by mass of the foodstuff is sodium bicarbonate.

13. A method comprising the step of using sodium bicarbonate to improve the mouthfeel of an extruded, toasted foodstuff having protein content in the range of 45% to 80% protein by mass.

14. A method comprising the step of using vital wheat gluten to improve the flavour and/or mouthfeel of an extruded, toasted foodstuff having a protein content in the range of 45% to 80% protein by mass.

15. A method comprising the step of using a dairy protein concentrate to improve the flavour and colour of an extruded, toasted foodstuff having a protein content in the range of 45% to 80% protein by mass.

16. A method comprising the step of using tapioca starch to modify the texture of an extruded, toasted foodstuff having a protein content in the range of 45% to 80% protein by mass.

17-18. (canceled)

19. An extruded foodstuff comprising:
a protein content of 45% to 80% protein by mass and a specific density of 0.10 to 0.40 g/cm³, over 50% of the protein comprises a vegetable protein isolate which has been at least partly hydrolysed by enzymic hydrolysis;
up to 30% by mass of wheat gluten; and
up to 5% by mass of the foodstuff is sodium bicarbonate.
